(19) United States
(12) Patent Application Publication
(10) Pub. No.: US 2024/0394569 A1
(43) Pub. Date: Nov. 28, 2024

(54) MULTI-MODEL INFERENCE PIPELINE AND SYSTEM

(71) Applicant: THE TORONTO-DOMINION BANK, TORONTO (CA)

(72) Inventors: FARNUSH FARHADI HASSAN KIADEH, TORONTO (CA); JIANING SUN, TORONTO (CA); SABA ZUBERI, TORONTO (CA); DEVINDER KUMAR, TORONTO (CA); SANGEETA MATHEW, MISSISSAUGA (CA)

(21) Appl. No.: 18/481,685

(22) Filed: Oct. 5, 2023

Related U.S. Application Data
(60) Provisional application No. 63/469,275, filed on May 26, 2023.

(51) Int. Cl. G06N 5/04; G06N 20/00

(52) U.S. Cl. CPC G06N 5/04; G06N 20/00

(57) ABSTRACT

Various examples are directed to providing a multi-model training and inference pipeline and environment using machine learning for a cloud environment.

### CROSS-REFERENCE TO RELATED APPLICATIONS

This application claims priority from U.S. Provisional Patent Application No. 63/469,275 Filed May 26, 2023, and entitled “MULTI-MODEL INFERENCE PIPELINE AND SYSTEM”, the entire contents of which are hereby incorporated by reference herein.

### FIELD

The present disclosure relates to a multi-model train and inference pipeline architecture, method and system and, specifically, a machine learning based architecture and implementation for cloud computing.

### BACKGROUND

In cloud computing, containers are packages of computer software which contain the necessary elements to run in any environment. In this way, containers virtualize the operating system and run anywhere, from a private data center to the public cloud or even on a developer's personal laptop. A container is a unit of software that packages code and its dependencies so the application runs quickly and reliably across computing environments. The container instances help in reducing the stress on developers to deploy and run their applications on cloud architecture.

A container is a system allowing software to be made modular, portable and standardized so it can be easily deployed on any computing environment.

In cloud computing, a component is an identifiable part of a larger program. Examples of cloud computing architectural components include infrastructure, application, service, runtime cloud, storage, management and security.

In cloud computing, data preparation (data prep) is the process of preparing raw data so that it is suitable for further processing and analysis. Key steps include collecting, cleaning, and transforming raw data prior to processing and analysis.

In a cloud computing system, current systems have a single pipeline model running to produce inferences based on a single input and generate a single output. These models are not scalable to multiple models and multiple inputs, are resource intensive and result in performance loss.

### SUMMARY

Furthermore, running multiple inference pipelines concurrently may require significant computational resources, such as Central Processing Unit (CPU), memory, and Graphics Processing Unit (GPU). Ensuring proper resource allocation and management becomes crucial to avoid resource contention and performance degradation.

A key consideration is how to combine and integrate multi models to produce desired results.

There is a need to provide multi-model inferences for batch use case in a cloud-computing environment which reduce redundancy, inefficiency and strain on computing environments, developers and resources.

In at least some implementations, there is disclosed herein a multi-model train pattern and inference pipeline architecture to address or overcome at least some of the disadvantages of prior methods and systems.

In at least some implementations there is disclosed a multi-model machine learning train and inference pipeline computing architecture in a cloud computing environment, comprising: a data preparation software container operable by a processor containing an input data set comprising at least two different data types contained in a single container; a set of training models applying machine learning and operable by the processor each trained independently and separately for being trained based on historical values for the input data set to predict future outcomes for each of the data types from the data preparation software container, a plurality of the set of training models grouped into at least one model train container for storing the trained models based on a type of data being predicted and another plurality grouped into another model train container having a different type of data contained therein; and a single inference model operable by the processor for each data type performing joint nested inference based on multiple input trained models received from the model train container for a particular type of data held within one container, the inference model for predicting, in a single inference component, multiple inferences for future values of the particular type of data having various subcategories.

In yet another implementation, there is disclosed a computer implemented method for multi-model machine learning train and inference in a cloud computing environment, the method comprising: storing, in a data preparation software container operable by a processor, an input data set comprising at least two different data types contained in a single container; providing, a set of training models applying machine learning and operable by the processor each trained independently and separately for being trained based on historical values for the input data set to predict future outcomes for each of the data types from the data preparation software container; grouping a plurality of the set of training models into at least one model train container for storing the trained models based on a type of data being predicted and grouping another plurality into another model train container having a different type of data contained therein; providing a single inference model operable by the processor for each data type performing joint nested inference based on multiple input trained models received from the model train container for a particular type of data held within one container; and predicting, via the single inference model and in a single inference component, multiple inferences for future values of the particular type of data having various subcategories.

In yet another implementation, there is disclosed a non-transitory machine-readable medium comprising instruction thereon that, when executed by a processor unit, causes the processor unit to perform operations comprising: storing, in a data preparation software container operable by a processor, an input data set comprising at least two different data types contained in a single container; providing, a set of training models applying machine learning and operable by the processor each trained independently and separately for being trained based on historical values for the input data set to predict future outcomes for each of the data types from the data preparation software container; grouping a plurality of the set of training models into at least one model train container for storing the trained models based on a type of data being predicted and grouping another plurality into another model train container having a different type of data contained therein; providing a single inference model operable by the processor for each data type performing joint nested inference based on multiple input trained models received from the model train container for a particular type of data held within one container; and predicting, via the single inference model and in a single inference component, multiple inferences for future values of the particular type of data having various subcategories.

### BRIEF DESCRIPTION OF THE DRAWINGS

These and other features will become more apparent from the following description in which reference is made to the appended drawings wherein:

FIG. 1a illustrates an example block model of a single model train pattern for batch use case.

FIG. 1b illustrates a multi-model train environment, computing modules and flow of operations that uses multiple (e.g. two) separate data stages and results in multiple (e.g. example shown as six) separate and distinctly customized machine learning models grouped and stored based on similarity in model train containers, in accordance with one or more aspects of the present disclosure.

FIG. 2a illustrates an example of single model inference pipeline.

FIG. 2b illustrates an example of a multi-model inference environment and flow between computing modules using machine learning, in accordance with one or more aspects of the present disclosure.

FIG. 3 illustrates a model deployment environment and computing components, in accordance with one or more aspects of the present disclosure.

FIG. 4 is a flowchart showing one example of a process flow that may be executed by the multi-model system of FIGS. 1B, 2B, and 3, in accordance with one or more aspects of the present disclosure.

FIG. 5 is an example computing device, in accordance with one or more aspects of the present disclosure.

### DETAILED DESCRIPTION

While various embodiments of the disclosure are described below, the disclosure is not limited to these embodiments, and variations of these embodiments may well fall within the scope of the disclosure. Reference will now be made in detail to embodiments of the present disclosure, examples of which are illustrated in the accompanying drawings. Wherever possible, the same reference numbers will be used throughout the drawings to refer to the same or like parts.

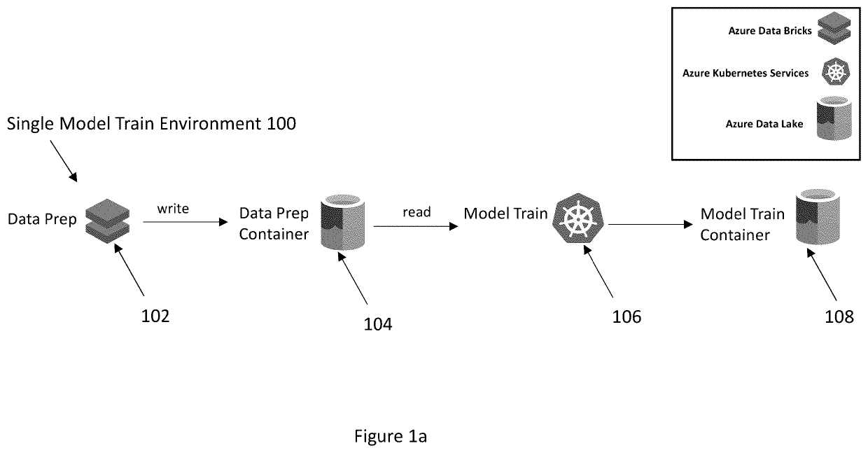

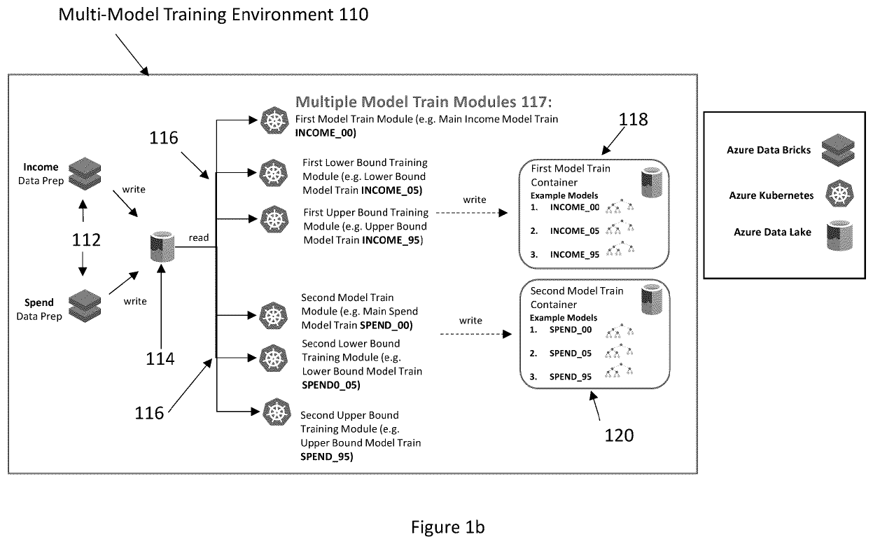

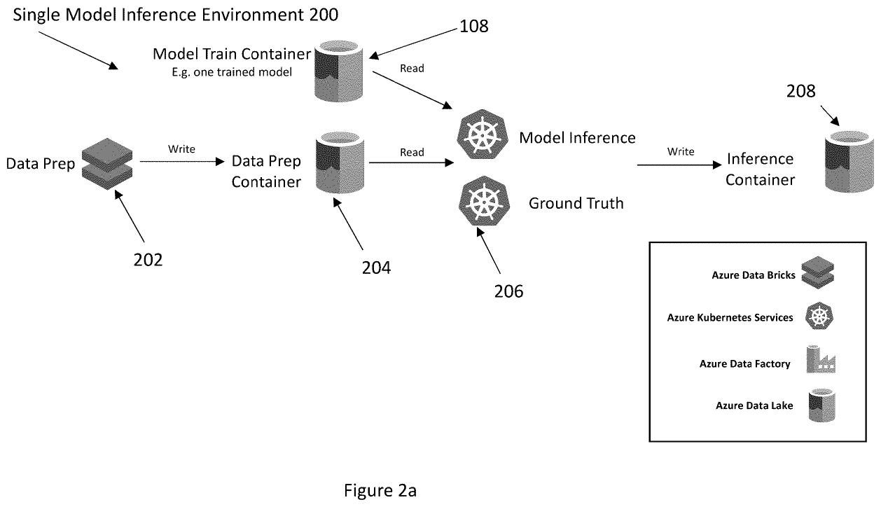

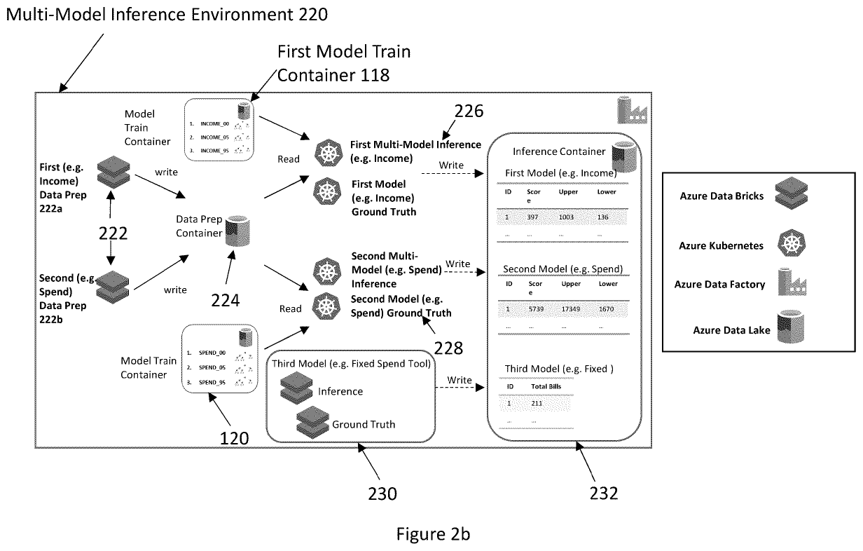

Generally, in at least some embodiments, there is provided a multi-model train pattern architecture and inference pipeline architecture for cloud computing using as inputs a plurality of input features or attributes (e.g. income and spend data) and associated values and further including a plurality of machine learning models whereby each of the machine learning models specifically configured, via training based on historical data of the types of attributes, to make target predictions for a particular attribute or feature (e.g. future income data value and future spend data value for a time period in the future) and in at least some aspects, associated upper and lower bounds of such predicted feature values. Examples of such multi-model train and pattern architectures are depicted in FIGS. 1b and 2b, in accordance with one or more aspects of the disclosure.

One of the technical challenges with multiple models in a system is designing a system as provided in the disclosed, in at least some embodiments, which allows combining the machine learning models to achieve desired results or put another way ensuring components in the system are able to communicate with each other and take advantage of dependencies in the data such as to produce inferences, e.g. joint inferences at the end.

There is provided, in various embodiments, a fully automated machine learning pipeline for multi-model inference and training in a cloud based structure. As will be discussed with reference to FIGS. 1b and 2b, the disclosed pipeline and computing inference and training environment which combines various data preparation containers for different data types as inputs into a single container, groups different trained models for different sub-data types or subcategories of data (but having a common similarity of the higher level data type-e.g. model trained for predicting a particular feature; model training for predicting an upper bound of the feature and model trained for predicting a lower bound of the feature combined into a single model train container as shown respectively in the first model train container 118 and the second model train container 120) for prediction into a single model train container as shown in FIG. 1b and combines multiple model inferences into a single inference container as shown in FIG. 2b such as to conveniently improve computational power, improve computational efficiencies and reduce computational resources.

Generally, a container is a package of software (also referred to as a container image) which is a ready-to-run software package containing everything needed to run an application: the code and any runtime it requires, application and system libraries, and default values for any essential settings. Generally, the containers virtualize the operating system and can run anywhere, including the public cloud.

Previously, only single model train pipeline and single model inference pipeline were envisaged and shown in FIGS. 1a and 2a. FIG. 1a illustrates the single model train pattern and FIG. 2a illustrates the single model inference pipeline. In single model pipelines, a single input, single output model is only provided using a single model to provide the single output based on the single input.

In at least some aspects and referring to FIGS. 1b and 2b, the disclosed method and system includes a multiple model inference pipeline system that has multiple machine learning models running concurrently (e.g. trained by conveniently utilizing knowledge from other machine learning models in the pipeline and inference via knowledge of other output and data derived from other models in the pipeline) in a cloud-computing environment.

FIG. 1b illustrates the multi-model train phase and FIG. 2b illustrates the inference phase of a multi-model pipeline for production, in accordance with various aspects of the disclosure. This disclosed training and inference environments integrate a single inference pipeline for each type of data (or simply related types of data) loading multiple models into the inference pipeline (e.g. first model inference 226 or second model inference 228), each inference pipeline having a set of inference data subcategories (for example but not limited to “future attribute value”, “upper bound attribute value” and “lower bound of attribute value” but other variations of subcategories, or related types of inferences for prediction models for predicting overlapping or similar data attributes, may be envisaged) and a single inference and ground truth.

Put another way, each inference pipeline as shown in the multi-model inference environment 220, such as the first model inference 226 or second model inference 228 may load a plurality of machine learning models (e.g. as stored in a first model train container 118 or a second model train container 120) into a single inference pipeline such that the models are able to account for dependencies between the trained models and to utilize a combined data preparation stage will be the same for all of the related models and thereby reducing the resources from multiple inference pipelines. Thus, in at least some embodiments with reference to FIGS. 1b and 2b, the machine learning components or model of similar types of data or related data predictions are configured to talk to one another such as by sharing data generated (e.g. each inference model utilizing output from other models in order to perceive their own learning such as in first model inference 226 or second model inference 228 thereby resulting in dependencies, which produce a joint inference at the end thereby optimizing efficiencies of the overall pipeline.

Thus, in at least some aspects, the proposed system and method may be advantageous in that it uniquely combines data from a variety of data sources, groups the data into a single data preparation container and uses the containers as inputs for a predictive machine-learning model. In at least some aspects, using an array of features as inputs in a predictive machine learning model and environment allows for the disclosed system and method to automatically produce predictions and distributions that are more accurate and representative of the dynamic characteristics of the input data, e.g. see FIGS. 1b and 2b. The proposed environments are also quicker and thus more cost-effective. As will be described, the proposed system reduces redundancy and overhead. It allows multiple models and inferences to be generated simultaneously resulting in multiple predictions and distributions.

In reference to FIG. 1a, a single model train environment 100 illustrates a current single model train pattern for batch use case, with a single machine learning model trained and used (see corresponding single model inference environment 200 and pipeline for batch use case in FIG. 2a). A typical model train pattern includes one data preparation container for a single data preparation stage (e.g. a single type of attribute or feature considered for training as input data thereby requiring only one data preparation stage) and one model train for a single model and model container thereby providing a single input and single output model as shown in FIGS. 1a and 2a. In the system of FIG. 1a, the single model data preparation component 102 which may run in Azure Databricks, which is a cloud analytics platform for Azure cloud services platform and enables an open Data Lake in Azure. The results are then written into a single model data preparation container 104 as shown in FIG. 1a, which are stored in a container such as Azure Data Lake. The data from the single model data preparation container 104 are read and used to train the single model 106 trained to predict only a single output, which occurs in Azure Kubernetes. These are then written into a single model train container 108, which contain model artifacts.

In reference to FIG. 1b, a multi-model training environment 110 exemplifies the proposed multi-model training pipeline which illustrates multiple machine learning models running in the environment and to be built in a cloud-based structure and in accordance with a further embodiment of the present disclosure. In this disclosed system of FIG. 1b for multi-model training, there are initially at least two different components for data preparation 112 collecting two different types of data and associated characteristics or values. For example, data preparation for a first type of data, e.g. income data, and data preparation of a second type of data, e.g. spend data for which multiple machine learning models will be used in the environment 110 to make predictions. Both components for data preparation 112 are written into a single multi-model data preparation container 114 thereby optimizing the containerization by containing two different types of data. As illustrated in the example flow of operations in FIG. 1b, the proposed multi-model training environment 110 reads from the multi-model data preparation container 114 and then trains multiple differently configured machine learning models or sub-models, shown as multiple as multiple model train modules 117, each trained for predicting a plurality of different attributes or features based on the input data types. The sub models within the multiple model train modules 117 are trained differently based on the input data and are used to predict multiple different outputs. In this specific example, six model trains are shown, however, any number of multiple models having multiple outputs may be considered. The plurality of models trained, shown in the multiple model train module 117 are grouped into two or more similar model groups 116 (e.g. a first and a second model grouping), based on the types of input data found within the multi-model data preparation container 114.

In this example of multi-model training environment 110, each of the plurality of models shown in the multiple model train modules 117, have one extreme gradient boosted model, XGboost (binary model) artifact, which is saved into the corresponding model train container. Thus, first and second model train containers 118 and 120 each hold multiple different models (in this illustrated case six machine learning models shown but other variations may be envisaged) each model trained differently using the input data, data types, attributes or features. Specifically, the first model train container 118 contains or stores training module data for a first set of models (e.g. first model train module, first lower bound training module, first upper bound training module) and second model train container 120 stores a second set of models form the multiple model train modules 117 (e.g. second model train module, second lower bound training module, second upper bound training module).

In some aspects, the XGBoost algorithm (Extreme Gradient Boosting) is used as the machine learning model (e.g. for the multiple model train modules 117) for the multi-model training and inference environment of FIGS. 1b and 2b. XGBoost is a boosted tree model, which means it is an ensemble of many individual decision trees, where subsequent trees are trained to correct the mistakes of previous trees. XGBoost uses gradient descent on a loss function to determine the optimal feature and threshold to use for every split. XGBoost is an efficient classification algorithm made up of many Decision Trees. The architecture of this algorithm as presented in the Figures is such that each successive decision tree minimizes the prediction error of its previous trees. Conveniently, this model can be more robust to variations in the data, such as when never-before-seen values appear. Finally, splits in trees can be more interpretable to humans and more amenable to explanation than the non-linear and highly complex interactions that underlie deep neural networks.

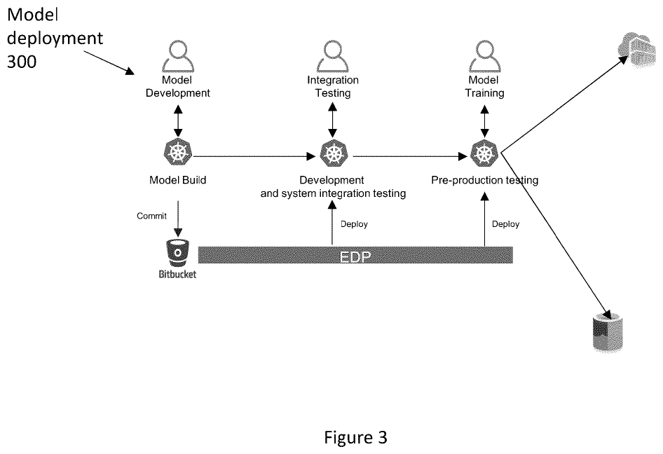

Now referring to the inference pipeline with reference to FIG. 2b, in one implementation, the architecture proposed in multi-model inference environment 220 which serves the models supports multi-model train patterns, and is fully automated via an enterprise delivery pipeline (EDP). Generally, such delivery pipeline automates the continuous deployment of the software project, such as for use in the environment of FIG. 2b. An example use case of model production and model deployment and computerized flow of operations is shown in the model deployment 300 of FIG. 3 illustrating the various stages of multi-model environment model development, integration testing, and model training.

Referring again to FIGS. 1b and 2b, in one aspect, the proposed multi-model system requires no manual work and is scalable to integrate a plurality of machine learning models in a cloud computing environment.

Conveniently, in at least some aspects, one advantage of having multiple trained machine learning models packaged within a single train container (e.g. first model train container 118 and second model train container 120 respectively containing multiple trained machine learning models) is that it simplifies the deployment process, as shown in FIG. 2b. Thus, rather than the multi-model inference environment and associated processors being configured to managing and deploying each model separately, the proposed architecture illustrated in FIG. 2b can deploy a single model train container for multiple trained models, thereby reducing the complexity and potential errors associated with managing multiple deployments.

Further conveniently, in at least some aspects, another advantage of the proposed integrated multi-model computerized architecture of FIGS. 1b and 2b is that it optimizes resource utilization by consolidating machine learning models into a single container as shown for example in the first model train container 118 of FIGS. 1b and 2b.

Additionally, as shown in the inference pipeline of FIG. 2b, the architecture can run, via one or more associated processors and processing units, a single container (e.g. first model train container 118 or second model train container 120) that hosts multiple models, as opposed to running separate instances for each and every model, thus utilizing computing resources more efficiently and improving processing time.

Once the trained models are generated, as seen in FIG. 1b depicting the multi-model training environment 110, the machine learning models are served into production (FIG. 2b).

With reference to FIG. 2a, a single model environment 200 exemplifies the current architecture for a single model inference pipeline. In this model, a single data type or single data feature (e.g. data for a particular feature) is integrated into a single model data preparation component 202, which is then written to a single model data preparation container 204. The single model data preparation container 204 and single model train container 108 (containing a single trained model) are simultaneously read, such as through Azure Kubernetes or another managed container orchestration service to run single model inference and ground truth 206. The results are then written into a single model inference container 208.

With reference to FIG. 2b, multi-model inference environment 220 displays a multi-model inference pipeline and architecture that is able to integrate multiple machine learning models in an optimized manner, as per an embodiment of the present disclosure. In this environment and architecture, there are two different types of data preparation components, shown as first data preparation 222a, and second data preparation 222b, generally referred to as multi-type data preparation 222. Each data preparation container containing a different type of data for which there will be associated predictions. Additional input data may be envisaged and can include a variety of different data types. In this example, the multi-model inference environment 220 is configured, via one or more processors or processing units, to predict a plurality of attributes for these two different types of input data.

In one non-limiting example, this can include “future value”, “upper bound distribution”, and “lower bound distribution” for data types such as “income” and “spend”. Although the present disclosure may include financial examples of data being processed for training and inference, these are non-limiting examples and other types of non-financial data may similarly be applied where multiple machine learning models are needed.

Conveniently, the multi-model inference environment 220 supports multi-model training as provided in form of input from FIG. 1a, is fully automated through the enterprise delivery pipeline, and is scalable to have a plurality of additional machine learning models to support.

The multi-model environment 220 is configured to take as input two different data preparation components and writes them into a single multi-model data preparation container 224. The multi-model data preparation container 224 is simultaneously read with trained model containers, first and second model train containers 118 and 120 to result in one inference and one ground truth, shown as first multi-model inference 226 and second multi-model inference 228 and associated ground truths. Thus, for each trained model container received by the multi-model inference environment 220, which contains multiple distinctly trained models, there is a single (joint) inference and one ground truth or target. Put another way, in one single inference run of the first multi-model inference 226 or the second multi-model inference 228, multiple trained models from the respective model train containers are loaded into the inference pipeline at a same time, each of the models may be trained to predict a future data type value and associated features for the future data type. Each inference may apply a subset number of the total set of models (e.g. 3 of the 6 models) that was previously trained in the multi-model training environment 110. Thus, there may be some dependency between the grouped trained models (e.g. and what they are optimized for) and each model's output may be used independently.

In at least some implementations, the multi-model inference environment 220 may further include a third model 230, which may be a rule based model for prediction and is also incorporated within the environment. In the particular example, the third model is used for predicting fixed future values for a third category of desired prediction as seen in the third model 230.

In at least one implementation, inferences from the proposed multi-model inference environment 220 of FIG. 2b (in cooperation with the multi-model training environment 110 of FIG. 1b) result in several different outputs. In one non-limiting example, a first inference predicts a future point value estimate for a feature; a second inference predicts an upper bound distribution value for the feature and a third inference predicts a lower bound distribution value for the future point value predicted. Together this provides a plurality of predictions for related features for a particular type of prediction (e.g. from a first set of models obtained from the first model train container 118), as seen in resultant inference container 232, which may be communicated with one or more other computing devices.

Additionally, referring again to FIG. 2b, as illustrated for a second type of data (e.g. processed by a second model train container 120), a single inference component (e.g. single second multi-model inference model 226) receives multiple trained models from a single model train container (e.g. from the second model train container 120) and provides multiple nested inferences for that type of data (e.g. spend data and associated featured) based on associated attributes. In one non-limiting example, this can include “future value”, “upper bound distribution”, and “lower bound distribution”. Thus, in at least some aspects, the inference container 232 has multiple nested inferences within it whereby all of these are automated which allows the multi-model inference environment 220 to perform a more complex inference task. Conveniently, by cascading models, each model may focus on a specific subtask while allowing the overall system to handle more intricate or multi-step predictions as described with respect to FIGS. 1b and 2b.

Generally, in at least some aspects, the multi-model data preparation container 224 may be a software environment or containerized application designed to perform data preparation tasks. Examples of the data preparation containers used for multi-model training and inference are seen in FIGS. 1b and 2b. The data preparation containers seen in these examples are stored in Azure Data Lake, specifically configured as described herein for multi-model training and inference but other similar applications may be envisaged. Furthermore, the multi-model data preparation container 224 may be a scalable data analytics and storage service hosted in the cloud which may additionally provide data preparation tasks such as data cleaning, transforming and organizing raw data from first format into a second format suitable for analysis and modelling. In at least some aspects, the multi-model data preparation container 224 further comprises a set of computing modules, including software and/or hardware tools, computing libraries and dependencies which enable manipulation and processing of data efficiently.

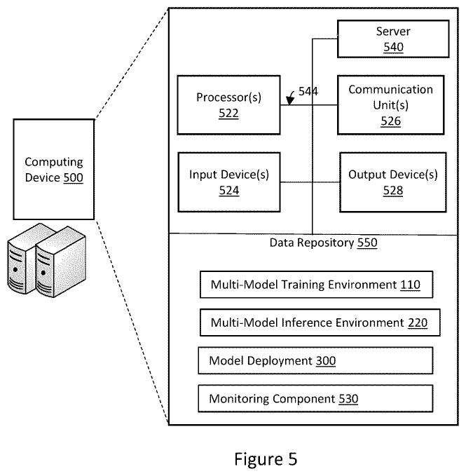

The proposed architecture of FIGS. 1b and 2b collaborating together as in the computing device of FIG. 5, in at least some aspects, allows sharing of the same containerized environment and workflow across different computing environments and simplifies the deployment of data preparation pipelines in cloud environments or distributed systems, enabling scalability and resource isolation.

In at least some aspects, the first and second model train containers 118 and 120 comprise multiple trained models. As seen in FIGS. 1b and 2b, the model train containers may be software containers that encapsulate multiple trained machine learning models, along with its dependencies and configurations, for deployment and execution in production environments. The containers can then be deployed and executed on various platforms, such as cloud services or on-premises infrastructure, without encountering compatibility or system dependency issues.

In some aspects, the multi-model inference environment 220 may also include a software monitoring component 530 shown in FIG. 5, provided within environment 220 of FIG. 2b, that combines the inference and ground truths such that each of the inferences can be used differently. In one non-limiting example, multiple different models are combined in an implementation of FIG. 2b for a nested inference within the inference component illustrated in multi-model inference environment 220. Thus, each inference predicts point estimates and associated distributions. In some aspects, ad hoc monitoring happens automatically within each module or component depicted in the multi-model inference environment 220 of FIG. 2b. Thus, in some aspects, monitoring is embedded within each module and is a component of the proposed multi-model pipeline.

In some implementations, Azure Databricks or similar cloud platforms may be used for data analytics and machine learning to prepare and model data. Typically, data preparation includes cleaning, formatting, preprocessing and combining data as performed within the data preparation container, e.g. data preparation container 224.

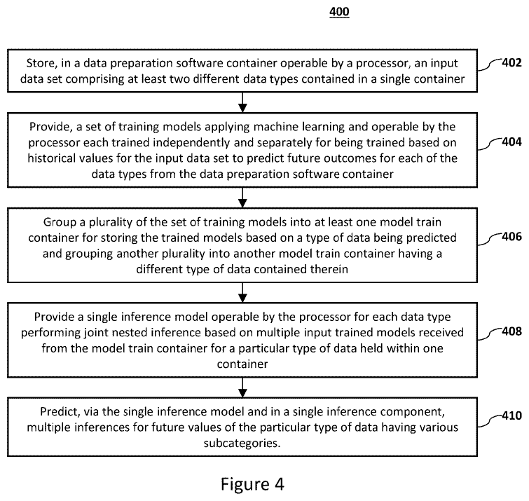

FIG. 4 is a flowchart showing one example of a process flow of operations 400 that may be executed by the multi-model training environment 110 of FIG. 1b and/or multi-model inference environment 220 of FIG. 2b, in an example of providing a multi-model inference and training pipeline that is fully automated and scalable to support multiple integrated machine learning models in a cloud computing environment. For example, the operations 400 may be performed by a computing device such as the computing device 500 of FIG. 5, the multi-model training environment 110 of FIG. 1b and multi-model inference environment 220 of FIG. 2b.

At operation 402, operations store, in a data preparation software container (e.g. see multi-model data preparation container 224) operable by a processor such as the processor(s) of the computing device 500 in FIG. 5, an input data set comprising at least two different data types contained in a single container (e.g. first data relating to income data; second data relating to spend data in a set of transactions communicated across a computing environment.

At operation 404, operations provide and receive a set of training models (e.g. training models trained in the multi-model training environment 110 of FIG. 1b providing multiple model train modules 117 prior to being served to the multi-model inference environment 220). The multiple training models apply machine learning in each model and operable by at least one processor, each of the multiple models is trained independently (e.g. see the multiple model train modules 117 of FIG. 1b) and separately for being trained based on historical values for the input data set to predict future outcomes for each of the data types from the data preparation software container.

At operation 406, similar groups of training modules are grouped into a same model train container (e.g. first model train container 118 containing 3 models trained to predict related features or attributes). That is, similar subsets of the plurality of the set of training models are grouped into respective model train containers for storing the trained models based on a type of data being predicted. For example a first grouping of trained models of one data type and another set of grouping of another plurality of models into another model train container having a different type of data contained therein.

For example, a set of machine learning models trained for predicting an attribute feature value and related attribute feature values or subtypes of that attribute feature may be grouped together in a single model train container as shown in FIG. 1b.

At operation 408, the operations of the computing device and environments illustrated in FIGS. 1b and 2b, provide a single inference model for each data type (and associated subtypes or attributes of data), as operable by the processor for performing inference for performing joint nested inference based on multiple input trained models received from the model train container for a particular type of data held within one container (e.g. single first multi-model inference model 226 and second multi-model inference model 228 each receiving model train containers from the multi-model training environment 110 for performing joint nested inference).

At operation 410, operation of the computing device and environments illustrated in FIGS. 1b and 2b, predict, via the single inference model and in a single inference component, multiple inferences for future values of the particular type of data having various subcategories (e.g. first model predicting an attribute value and related attribute values; second model predicting another attribute value and related attribute values).

Reference is next made to FIG. 5, which is a diagram illustrating in block form an example computing device 500 providing the multi-model training and inference pipeline and systems described herein.

The computing device 500 includes at least one processor 522 (such as a microprocessor) which controls the operation of the computer system. The processor 522 is coupled to a plurality of components and computing components via a communication bus or channel, shown as the communication channel 544.

Computing device 500 further comprises one or more input devices 524, one or more communication units 526, one or more output devices 528 and one or more servers 540 or server components. Computing device 500 also includes one or more data repositories 550 storing one or more computing modules and components including but not limited to a multi-model training environment 110; a multi-model inference environment 220; and a model deployment 300 module and associated computerized modules as for example discussed in reference to FIGS. 1b, 2b and 3.

Communication channels 544 may couple each of the components for inter-component communications whether communicatively, physically and/or operatively. In some examples, communication channels 544 may include a system bus, a network connection, an inter-process communication data structure, or any other method for communicating data.

Referring to FIG. 5, one or more processors 522 may implement functionality and/or execute instructions within the computing device 500 such as discussed operations with reference to FIGS. 1b and 2b. The processor 522 is coupled to a plurality of computing components via the communication bus or communication channel 544 which provides a communication path between the components and the processor 522. For example, processors 522 may be configured to receive instructions and/or data from storage devices, e.g. data repository 550, to execute the functionality of the modules shown in FIG. 5, among others (e.g. operating system, applications, etc.).

Computing device 500 may store data/information as described herein for the process of performing the functionalities and processes as described further herein.

One or more communication units 526 may communicate with external devices via one or more networks by transmitting and/or receiving network signals on the one or more networks. The communication units may include various antennae and/or network interface cards, etc. for wireless and/or wired communications.

Input devices 524 and output devices 528 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 544).

The one or more data repositories 550 may store instructions and/or data for processing during operation of the multi-model training environment 110, the multi-model inference environment 220 and the model deployment 300. The one or more storage devices may take different forms and/or configurations, for example, as short-term memory or long-term memory. Data repositories 550 may be configured for short-term storage of information as volatile memory, which does not retain stored contents when power is removed. Volatile memory examples include random access memory (RAM), dynamic random access memory (DRAM), static random access memory (SRAM), etc. Data repositories, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using wired or wireless technologies, such are included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. Also, the techniques could be fully implemented in one or more circuits or logic elements. The techniques of this disclosure may be implemented in a wide variety of devices or apparatuses, an integrated circuit (IC) or a set of ICs (e.g., a chip set).

One or more currently preferred embodiments have been described by way of example. It will be apparent to persons skilled in the art that a number of variations and modifications can be made without departing from the scope of the disclosure as defined in the claims.

1. A multi-model machine learning train and inference pipeline computing architecture in a cloud computing environment, comprising:
a data preparation software container operable by a processor containing an input data set comprising at least two different data types contained in a single container;
a set of training models applying machine learning and operable by the processor each trained independently and separately for being trained based on historical values for the input data set to predict future outcomes for each of the data types from the data preparation software container, a plurality of the set of training models grouped into at least one model train container for storing the trained models based on a type of data being predicted and another plurality grouped into another model train container having a different type of data contained therein; and
a single inference model operable by the processor for each data type performing joint nested inference based on multiple input trained models received from the model train container for a particular type of data held within one container, the inference model for predicting, in a single inference component, multiple inferences for future values of the particular type of data having various subcategories.

2. The multi-model machine learning model architecture of claim 1 wherein each single inference model performs nested inferences comprising a future point estimate, an upper bound of distribution and a lower bound of distribution for one of the input data types.

3. The multi-model machine learning model architecture of claim 1 wherein the single inference model is an XGBoost model.

4. The multi-model machine learning model architecture of claim 1 further comprising a monitoring component operable by the processor that combines the inferences and ground truths at each single inference model such that each of the inferences are used differently.

5. The multi-model machine learning model architecture of claim 1 wherein the single inference model has a single ground truth for multiple subcategories of output inferences.

6. The multi-model machine learning model architecture of claim 1 wherein, in an inference stage, various incoming data types received for inference of future values in a data preparation stage are combined and written into a single data preparation container.

7. The multi-model machine learning model architecture of claim 1 wherein the single inference model is configured to read from multiple models contained in the model train container at a same time and generate model inference providing multiple predictions in a single inference run for each of the multiple models in the model train container.

8. A computer implemented method for multi-model machine learning train and inference in a cloud computing environment, the method comprising:
storing, in a data preparation software container operable by a processor, an input data set comprising at least two different data types contained in a single container;
providing, a set of training models applying machine learning and operable by the processor each trained independently and separately for being trained based on historical values for the input data set to predict future outcomes for each of the data types from the data preparation software container;
grouping a plurality of the set of training models into at least one model train container for storing the trained models based on a type of data being predicted and grouping another plurality into another model train container having a different type of data contained therein;
providing a single inference model operable by the processor for each data type performing joint nested inference based on multiple input trained models received from the model train container for a particular type of data held within one container; and
predicting, via the single inference model and in a single inference component, multiple inferences for future values of the particular type of data having various subcategories.

9. The method of claim 8, wherein each single inference model performs nested inferences comprising a future point estimate, an upper bound of distribution and a lower bound of distribution for one of the input data types.

10. The method of claim 8, wherein the single inference model is an XGBoost model.

11. The method of claim 8, further comprising: providing a monitoring component operable by a processor that combines the inference and ground truths at each single inference model such that each of the inferences are used differently.

12. The method of claim 8, wherein the single inference model has a single ground truth for multiple subcategories of output inferences.

13. The method of claim 8 wherein, in an inference stage, various incoming data types received for inference of future values in a data preparation stage are combined and written into a single data preparation container.

14. The method of claim 8 wherein the single inference model is configured to read from multiple models contained in the model train container at a same time and generate model inference providing multiple predictions in a single inference run for each of the multiple models in the model train container.

15. A non-transitory machine-readable medium comprising instruction thereon that, when executed by a processor unit, causes the processor unit to perform operations comprising:
storing, in a data preparation software container operable by a processor, an input data set comprising at least two different data types contained in a single container;
providing, a set of training models applying machine learning and operable by the processor each trained independently and separately for being trained based on historical values for the input data set to predict future outcomes for each of the data types from the data preparation software container;
grouping a plurality of the set of training models into at least one model train container for storing the trained models based on a type of data being predicted and grouping another plurality into another model train container having a different type of data contained therein;
providing a single inference model operable by the processor for each data type performing joint nested inference based on multiple input trained models received from the model train container for a particular type of data held within one container; and
predicting, via the single inference model and in a single inference component, multiple inferences for future values of the particular type of data having various subcategories.
